(19) United States
(12) Patent Application Publication
(10) Pub. No.: US 2007/0051247 A1
(43) Pub. Date: Mar. 8, 2007

(54) Limited cup coffeemaker

(76) Inventor: David S. Felty, Eau Claire, WI (US)

Correspondence Address: Paul M. Denk;Suite 170, 763 S. New Ballas Rd., St. Louis, MO, 63141, US

(21) Appl. No.: 11/514,536

(22) Filed: Sep. 2, 2006

Related U.S. Application Data
(60) Provisional application No. 60/713,778, filed on Sep. 2, 2005.

(51) Int. Cl. A47J 31/00

(52) U.S. Cl. 99/279

(57) ABSTRACT

A machine and method makes one or two cups of coffee, determined by the water placed in the machine and the selection made by the consumer. A consumer places coffee grounds into a basket and water into a reservoir then presses a button or buttons to brew coffee. A sensor checks for water in the reservoir then activates a heater which heats the water. The machine pipes the heated water through the coffee grounds and to one or two baskets as selected by the consumer, and the coffee drips into the corresponding one or two cups. A sight gauge upon the reservoir reveals the level of water to prevent overfilling by the consumer. The machine brews coffee and delivers it directly to one cup or two cups for immediate consumption. The present invention has an ovoid appearance, relay method thermostat circuitry, a solenoid switch, and filter baskets.

### CROSS-REFERENCE TO RELATED APPLICATION

This is a non-provisional application which claims priority to the provisional application Ser. No. 60/713,778 filed Sep. 2, 2005 and commonly owned by the same inventor. The above noted application is incorporated herein by reference.

### BACKGROUND OF THE INVENTION

This invention relates generally to electric coffee brewing machines and more specifically to thermostat controlled brewers.

For many years, drip type electric coffee brewers have efficiently made coffee in homes, offices, and rooms of many kinds. Generally a brewer has a reservoir for receiving cold water, an electric resistance heating element for heating the water for brewing, a brew basket for holding ground coffee during passage of heated water, and a housing to contain the component parts. In operation, a consumer pours cold water into the reservoir and places ground coffee in a filter and then into the brew basket. The consumer then activates the brewer where cold water is heated by the heating element, and passes to the brew basket. Heated water then saturates the ground coffee and liquid coffee drips into a cup located below the brew basket. Finished with brewing, a consumer removes the brew basket and cleans it for the next use.

In hotels, guests often find an electric coffee brewer. The coffee brewer lets the guest get a good start to the day with coffee brewed their way, in the room. However, guests depart a room and leave cleaning of the coffee brewer to hotel staff. Coffee remains a strong substance that imparts its flavor to containers. If the hotel staff does not clean a coffee brewer promptly, the coffee flavor of a prior guest remains in the brewer for the next guest. Also when guests depart a room, the coffee brewer must guard against hazards from dry reservoirs and partially full reservoirs. Common coffee brewers have a time limit for an automatic shutoff that limits those hazards yet permits reheating of a coffee pot for a certain time.

In homes, people make coffee for themselves. Coffee brewers often have a clear glass pot with servings marked. A consumer fills the pot with water to match the cups of coffee desired. At home, most consumers have two or less cups of coffee yet coffee pots have markings for five or more servings. In many locations, existing coffee brewers are too large for space and for the volume of coffee desired.

### DESCRIPTION OF THE PRIOR ART

Various types of small coffee brewers have appeared in the prior art for many years. Decanters of various diameters and heights have held brewed coffee for dispensing to groups. Coffee pots of various decors have graced offices and kitchens of all kinds. Other brew baskets have sought to improve maintenance and cleaning of coffee brewers.

The U.S. patent to Albrecht, U.S. Pat. No. 7,081,263 describes a combination of brew basket and filter pack, a brewing system with a machine that uses filter packs and brew baskets, and a method of brewing coffee. This patent generally describes brewing a single cup of coffee or other heated beverage. The method utilizes a brew basket in different steps of brewing coffee and maintaining a coffee pot. Generally the method has the brew basket being used once and then disposed. The special brew basket has a shape suitable to fit within a brewing machine and a flange to guide and to support the loaded basket. The brew basket may or may not have a filtering medium for added coffee. This application discloses a coffee brewing method emphasizing a brew basket but does not describe temperature control by a thermostat nor a sight gauge to determine water level in a reservoir.

### SUMMARY OF THE INVENTION

This invention generally defines a machine and method to make one or two cups of coffee as determined by the amount of water placed in the machine and by the selection made by the consumer. A consumer places coffee grounds into a basket and water into a reservoir then presses a control to brew coffee. A control assembly determines the presence of water in the reservoir then activates a heater. The heater heats the water which is then piped through the coffee grounds. The present invention pipes the heated water to either one or two baskets, as selected by the consumer, and the coffee drips into the corresponding one or two cups.

To assist consumers, a sight gauge upon the reservoir reveals the level of water. If a consumer sees insufficient water in the gauge, the consumer can add water to the reservoir prior to brewing. Also as a consumer adds water, a full sight gauge deters an observant consumer from overfilling the reservoir. In operation, the present invention brews coffee and delivers it directly to a cup or cup for immediate drinking, but not to a warmed pot for later consumption.

The present invention also has a partial ovoid appearance, relay method thermostat circuitry, a solenoid switch, one or two cup brewing, and either permanent or disposable filter baskets.

Therefore, the principal object of this invention is to provide a measured amount of water for one or two cup brewing of coffee.

Another object of this invention is to provide controls for a consumer to select which of two cups receive brewed coffee.

Still another object of this invention is to provide a washable and reusable basket for containing coffee grounds.

And another object of this invention is to provide a heat resistant base to support one or two cups.

These and other objects may become more apparent to those skilled in the art upon review of the summary of the invention as provided herein, and upon undertaking a study of the description of the preferred embodiment in view of the drawings.

### BRIEF DESCRIPTION OF THE DRAWINGS

In referring to the drawings,

FIG. 1 shows an isometric view of the two cup embodiment of the present invention with cups not shown;

FIG. 2 shows a front view of the two cup embodiment of the present invention;

FIG. 3 provides a back view of the two cup embodiment illustrating the lid and handle of the brew basket or tray;

FIG. 4 describes the left side view of the two cup embodiment showing the sight gauge and the handle of the tray;

FIG. 5 describes the right side view of the two cup embodiment showing the pivoting of the tray;

FIG. 6 shows a top view of the two cup embodiment of the present invention;

FIG. 7 shows a bottom view of the two cup embodiment with feet for the present invention;

FIG. 8 shows an isometric view of the one cup embodiment of the present invention without a cup shown;

FIG. 9 shows a front view of the one cup embodiment of the present invention;

FIG. 10 provides a back view of the one cup embodiment illustrating the lid and the electrical cord;

FIG. 11 describes the left side view of the one cup embodiment showing the sight gauge and the edge of the brew basket or tray;

FIG. 12 describes the right side view of the one cup embodiment showing the pivoting of the tray;

FIG. 13 shows a top view of the one cup embodiment of the present invention;

FIG. 14 shows a bottom view of the one cup embodiment with feet for the present invention;

FIG. 15 illustrates the circuitry of the two cup embodiment of the present invention;

FIG. 16 illustrates the circuitry of the two cup embodiment with a beeper;

FIG. 17 illustrates the circuitry of the one cup embodiment of the present invention;

FIG. 18 shows the two cup tray opened away from the brewer;

FIG. 19 shows a front view of a two cup filter and FIG. 20 shows a top view of the two cup filter; and,

FIG. 21 shows the one cup tray opened away from the brewer, FIG. 22 shows a single cup filter, and FIG. 23 shows a one cup filter.

Corresponding reference numerals will be used throughout the several figures of the drawings.

### DESCRIPTION OF THE PREFERRED EMBODIMENT

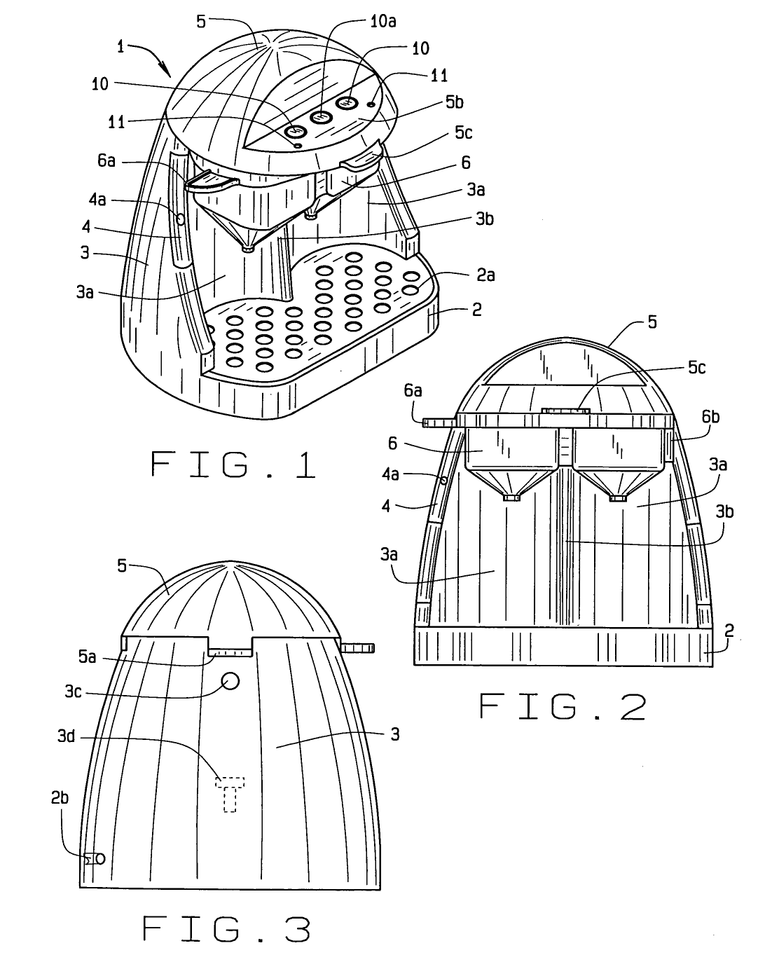

In referring to FIG. 1 of the drawings, the concept of this invention is readily disclosed. It includes, as depicted therein, a machine 1 having an upright enclosed reservoir 3 defining the rear of the machine 1, a generally flat base 2 beneath and extended forward of the reservoir 3, a lid 5 over the reservoir 3 and hingedly connected to a shelf 5b, control mechanisms upon the shelf 5b for a consumer to press, and a tray 6 of two baskets for holding coffee grounds. Internally, the machine 1 has an intake pipe connected to the bottom of the reservoir 3, a heater 8 upon the intake pipe, additional controls proximate to the heater 8 including a solenoid switch 9a, and a riser ascending from the intake pipe that carries heated water through and above the reservoir 3 and into the brew basket or tray 6. The heated water, when in the tray 6, brews the coffee and descends into a cup as selected by the consumer. The heated water attains a temperature from approximately 100° F. to approximately 220° F. Depending upon local atmospheric pressure, the heated water may attain a temperature above or below the boiling point. Beginning from the base 2, the machine 1 has a heat resistant base 2 to support two cups. In the preferred embodiment, the base 2 resists heat with a removable metal plate, or drip tray 2a containing a pattern of holes. The drip tray has a complementary shape to fit within the base 2 and the reservoir 3. To ease removal and insertion of the drip tray upon the base, the drip tray has at least one handle, generally centered upon the rear of the drip tray.

Upon the left side, the reservoir 3 extends upwards leaving a generally half cylinder form, or chamber 3a, to accept a cup. Towards the upper end of the reservoir 3 at the edge of the cylinder away from the center of the machine 1, a sight gauge 4 indicates the level of water within the reservoir 3. In the preferred embodiment, the sight gauge 4 has a transparent plastic that shows the depth of water corresponding to the number of cups of coffee desired. The sight gauge further includes a ball 4a that floats upon the water placed into the reservoir. The position of the ball indicates the approximate water level to the user. Opposite the left side, the right side also forms as the reservoir 3 extends upward from the base 2. The right side has a generally half cylinder form or chamber 3a to accept a cup. Between the left side and the right side, the half cylinder shapes intersect forming a generally centered spine 3b to support the upper components of the present invention 1.

Above the base 2 and the reservoir 3, the machine 1 has a lid 5 openable to the reservoir 3. The lid 5 connects by a hinge 5a, shown in FIG. 3, atop the reservoir 3 to the rear of the machine 1. The lid 5 spans the upper width of the machine 1 and partially across the upper depth. Forward and beneath the lid 5, the machine 1 has a shelf 5b. The shelf 5b has the means to indicate when the brewing takes place. In the preferred embodiment, the indicator means is two lights 11 and related switches. The switches can be toggle, pressure, buttons and the like. The preferred embodiment uses switches in the form of buttons 10 that operate the present invention 1, where a button 10 and corresponding light 11 control brewing to the left side and to the right side of the machine 1 respectively. A center button 10 serves as a STOP button 10a for the left side and the right side. In alternate embodiments, the indicator means can be a liquid crystal display, a hinged flag, a pin that pops up, a beeper, a buzzer, or sound generator among other things. Forward of the shelf 5b, a tab 5c permits the consumer to grasp the lid 5 of the machine 1.

Beneath the shelf 5b, a brew basket or tray 6 abuts the shelf 5b and communicates with the riser. The tray 6 has a handle 6a extending toward the left side of the present invention 1, approximate in elevation to the top of the sight gauge 4. Opposite the handle 6a, the tray 6 hingedly connects to the right side of the reservoir 3.

Moving to FIG. 2, the tray 6 has a hinged connection to an armature 6bupon the right side. The armature 6b has a vertical hollow cylindrical sleeve that accepts a pin from the tray 6. The armature 6b permits the tray 6 to swing outwards from the machine 1 where a consumer adds and removes coffee grounds. In the preferred embodiment, the tray 6 contains single use plastic baskets that contain coffee grounds which a consumer disposes after use. Also, the tray has two halves, where each half has a generally four sided funnel like shape with the narrow opening of the half located towards the base 2. In an alternate embodiment, the tray 6 itself serves as the basket for one or both sides of the machine 1. A consumer adds ground coffee contained in a filter material to the basket, brews coffee, and then washes out the tray 6.

As can also be noted in FIG. 3, the machine 1 includes wiring 2b to supply electric power. Mentioned previously, the lid 5 connects to the machine 1 by one or more hinges 5a and the handle 6a upon the tray 6 extends outward and toward the left of the machine 1. As a safety feature, the body 3 has an overflow hole 3c located proximate to the hinge 5a. The overflow hole allows water poured by a user that exceeds the volume needed for two cups to exit the brewer. Also located within the body 3 and below the overflow hole 3c, a water sensor 3d regulates the brewing of a single cup. During use of the brewer, a user fills water into the reservoir through the open lid and may exercise little care in the volume of water placed therein. When a user selects brewing of one cup, the weight of the water in excess of one cup accelerates the brewing of a single cup of coffee which raises the risk of burnt coffee or an overflow into a single cup. A water sensor 3d, located within the reservoir, signals the BREW function to brew only one cup's worth of coffee though more water is present in the reservoir. In the preferred embodiment, the water sensor has a blade attached to the body of the reservoir and a sensor located at the elevation of the reservoir corresponding to the volume of one cup.

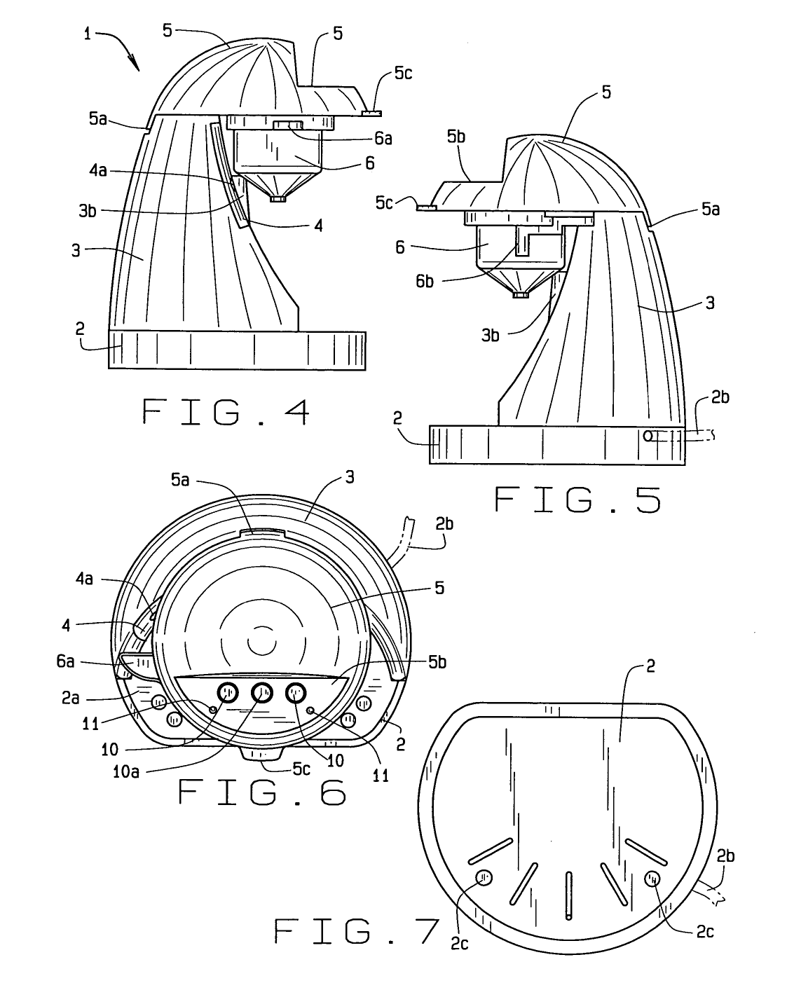

Viewing the right side of the invention 1, FIG. 4 shows a base 2 generally rectangular in a side view. The reservoir 3 rests upon the base 2 and attaches partially along the perimeter of the base 2. The reservoir 3 extends upwardly from the base 2 with tapering curves. The back of the reservoir 3 curves gently towards the hinge 5a, while the curve at the front, curves sharply inwards ahead of the tray 6. The front curve contains the sight gauge 4 at the edge of the curve and as generally located in the upper half of the front curve. A ball 4a floats within the sight gauge and provides a visual indicator of water level to the user of the brewer. At the top of the reservoir 3, the lid 5 joins the reservoir 3 at the hinge 5a. Opposite the hinge 5a, the lid 5 has a tab 5c that a user grasps to lift the lid 5 for adding water. Beneath the lid 5, the tray 6 depends above the base 2. In this view, the right end of the tray 6 has a handle 6a extending perpendicular to the tray 6 and suitable for gripping by a consumer's thumb. In the center, the tray 6 rests above the spine 3b formed into the reservoir 3.

FIG. 5 shows the left side of the invention 1. Here the wire 2b enters the base 2 and the reservoir 3 extends upwardly from the base 2. As in the left side, the reservoir 3 curves upwardly with the back curving gently towards the hinge 5a and the front curving sharply ahead of the tray 6. The tray 6 on the left end has a depending pin, contained within the armature 6b. The armature 6b has a cylinder to receive the pin and its own pinned connection to the front curve of the reservoir 3. With the tray 6, the armature 6b, and the front curve having pinned connections, the tray 6 rotates inward and outward from the reservoir 3 for a user to add and to remove coffee grounds, and to clean the tray 6.

From above, the invention 1 appears as in FIG. 6. The base 2 has a generally rounded shape beneath the reservoir 3 and a straight edge or chord upon the perimeter defining the front of the invention 1. Adjacent to the chord, the base 2 has a plate upon which heated cups rest. The plate has a pattern of holes to insulate the base 2 from heated cups. Towards the right side, the reservoir 3 curves upward and contains the sight gauge 4 with the ball 4a floating within. Ahead of the sight gauge 4, the handle 6a extends from the tray 6. Inwards from the handle 6a, the lid 5 has a wedge like portion removed to expose a flat shelf 5b. The shelf 5b has cutouts that admit buttons 10 and lights 11 or LEDs in a symmetric arrangement of three buttons 10 and two lights 11. Two buttons 10 activate brewing in either side of the tray 6, and a third button 10a centered between the other two stops brewing. The lights 11 located on each side of the tray 6 illuminate when the brew button 10 is pressed, thus showing the consumer that brewing is in progress. Outwards of the center button 10a, the lid 5 has a tab 5c that permits the user to lift the lid.

In operation, the present invention 1 accounts for variable amounts of water placed in the reservoir 3 by a self locking circuit 9b of the control assembly 9. The self locking circuit 9b controls the present invention 1 as described below. When the reservoir 3 has no water and a consumer presses a BREW button 10, the LED 11 illuminates and remains on during the brewing cycle. The LED turns off at the end of the brewing cycle or when the consumer presses the STOP button 10a.

When the reservoir 3 has less than a cup of water, a consumer places a cup in either position and presses the corresponding BREW button 10 above the cup. The corresponding LED illuminates and coffee brews until the consumer presses the STOP button 10a or the reservoir 3 empties of water and the present invention 1 automatically stops operating. Then the LED turns off, alerting the consumer to a cup partially full of coffee.

When the reservoir 3 has at least one cup of water but less than two cups, a consumer places a cup in either position and presses the corresponding BREW button 10 above the cup. The corresponding LED illuminates and coffee brews until the consumer presses the STOP button 10a or the present invention 1 delivers one cup of coffee and then stops automatically. And then the LED turns off, alerting the consumer to a cup full of coffee. Alternatively, a consumer places two cups within the present invention 1, and presses both BREW buttons 10, illuminating both LEDs. The present invention 1 then delivers coffee to both cups until the reservoir 3 empties of water and the present invention 1 stops automatically or until the consumer presses the STOP button 10a.

When the reservoir 3 has at least two cups of water, a consumer places one or two cups in the present invention 1. The consumer then presses the corresponding BREW buttons 10 and the appropriate LEDs illuminate. The present invention 1 then delivers hot coffee for one or two cups as selected by the consumer and the units stop automatically, or until the consumer presses the STOP button 10a. Alternatively, the consumer places one cup in either position and presses the BREW button 10 above the cup. As before, the present invention 1 brews coffee until the cup fills with coffee and the present invention 1 stops automatically or the consumer presses the STOP button 10a. If the consumer changes her mind and adds a second cup to the remaining position, the present invention 1 brews coffee for the second cup after the consumer presses the other BREW button 10, illuminating the other LED. In this alternative, the present invention 1 will fill the first cup first and then the second cup. In the preferred embodiment, the self locking circuit 9b has a relay thermostat 9c.

Opposite to FIG. 6, the bottom view of the present invention 1 appears in FIG. 7. Upon the circular portion, the base 2 has two or more feet 2d to stabilize the invention 1 when upright.

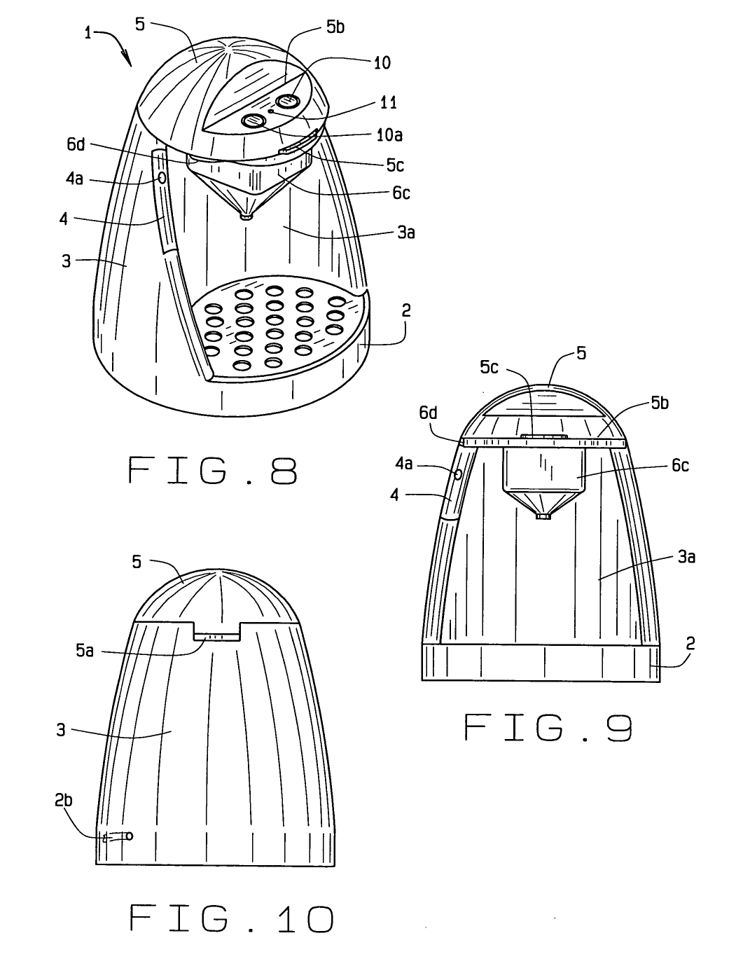

And then, FIG. 8 of the drawings discloses the single cup version of this invention 1. It includes, as depicted therein, a machine 1 having an upright enclosed reservoir 3 defining the rear of the machine 1, a generally flat base 2 beneath and forward of the reservoir 3, a lid 5 over the reservoir 3 and hingedly connected to a shelf 5b, control mechanisms upon the shelf 5b for a consumer to press, and one brew basket or tray 6c for holding coffee grounds. Internally, the machine 1 has an intake pipe connected to the bottom of the reservoir 3, a heater 8 upon the intake pipe, a control assembly 9 proximate to the heater 8, and a riser ascending from the intake pipe that passes heated water through and above the reservoir 3 and into the tray 6c. The heated water, when in the tray 6c, brews the coffee and descends into a cup. Beginning from the base 2, the machine 1 has a heat resistant base 2 to support one cup. In the preferred embodiment, the base 2 resists heat with a removable metal plate 2a containing a pattern of holes. The plate has a complementary shape to fit within the base 2 and the reservoir 3.

Upon the base 2, the reservoir 3 extends upwards leaving an internal generally half cylinder form or chamber 3a to accept a cup. Towards the upper end of the reservoir 3 at the edge of the cylinder left of the center of the machine 1, a sight gauge 4, augmented with a floating ball 4a, indicates the level of water within the reservoir 3. In the preferred embodiment, the sight gauge 4 has a transparent plastic that shows the depth of water corresponding to cups of coffee desired.

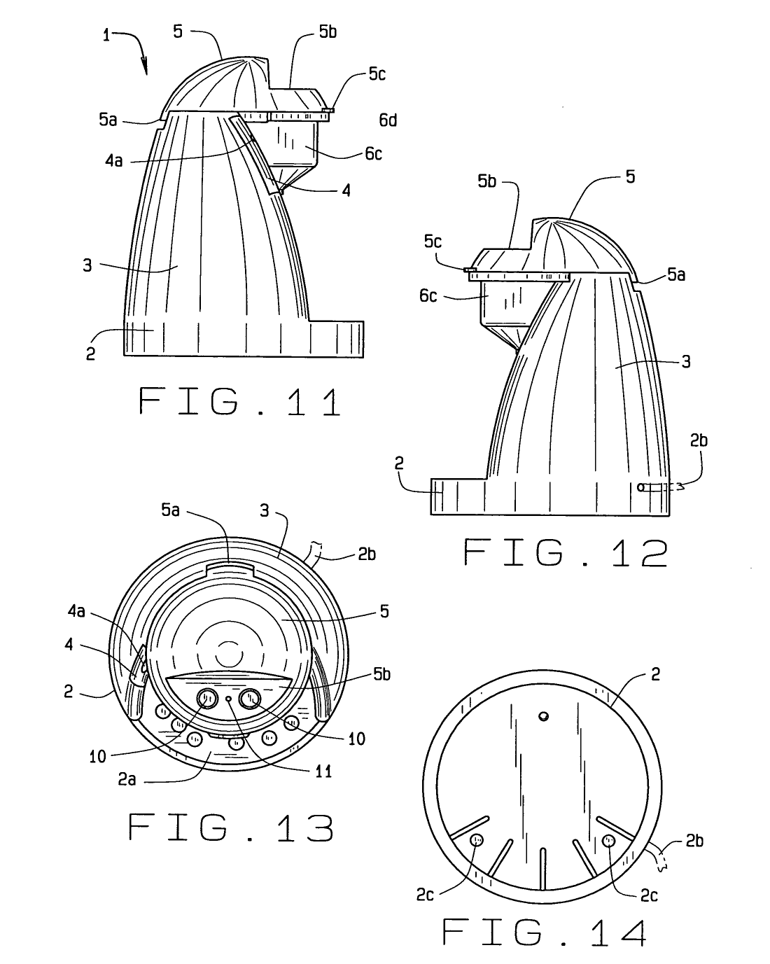

Then in FIG. 9, the tray has a single basket 6c for receiving coffee grounds. The basket preferably has a generally four sided funnel like shape with the narrow opening of the half located towards the base 2. Above the base 2 and the reservoir 3, the machine 1 has a lid 5 openable to the reservoir 3. The lid 5 connects by a hinge 5a, later shown in FIG. 10, atop the reservoir 3 to the rear of the machine 1. The lid 5 spans the upper width of the machine 1 and partially across the upper depth. Forward and beneath the lid 5, the machine 1 has a shelf 5b. The shelf 5b has the means to indicate brewing takes place and buttons 10 to operate the present invention 1. In the preferred embodiment, the indicator means is one light 11 and related switches. The switches can be pressure, blade, toggle, buttons and the like. The preferred embodiment uses switches in the form of buttons 10 that operate the present invention 1. Here in the single cup embodiment, a BREW button 10 and corresponding light 11 control brewing for the cupful of coffee. A second button serves as a STOP button 10a. In alternate embodiments, the indicator means can be a liquid crystal display, a hinged flag, a pin that pops up, a beeper, a buzzer, or sound generator among other things. Forward of the shelf 5b, a tab 5c permits the consumer to grasp the lid 5 of the machine 1.

Beneath the shelf 5b, a tray 6c abuts the shelf 5b and communicates with the riser. The tray 6c has a handle 6d extending toward the left side of the present invention 1 approximate the top of the sight gauge 4. Opposite the handle 6d, the tray 6c hingedly connects to the right side of the reservoir 3.

Moving to FIG. 9, the tray 6c has a hinged connection to the front curve on the right side of the reservoir 3. The tray 6c has a vertical hollow cylindrical pin upon an arm that fits into a cylindrical sleeve within the right side of the reservoir 3. The pin on the arm permits the tray 6c to swing outwards from the machine 1 where a consumer adds and removes coffee grounds. In the preferred embodiment, the tray 6c contains a single use plastic basket that contains coffee grounds which a consumer disposes after use. In an alternate embodiment, the tray 6c itself serves as the basket for the machine 1 where a consumer adds coffee grounds within a filter material into the basket, brews coffee, and then washes out the tray 6c.

As can also be noted in FIG. 10, the machine 1 includes wiring 2b to supply electric power and the lid 5 connects to the machine 1 by a hinge 5a. The handle 6d upon the tray 6c extends toward the left of the machine 1 near the sight gauge 4.

Viewing the right side of the invention 1, FIG. 11 shows a base 2 generally rectangular in a side view. The reservoir 3 rests upon the base 2 and attaches partially along the perimeter of the base 2. The reservoir 3 extends upwardly from the base 2 with tapering curves. The back of the reservoir 3 curves gently towards the hinge 5a while the curve at the front deflects sharply inwards ahead of the tray 6c. The front curve contains the sight gauge 4 at the edge as generally located in the upper half of the front curve. A ball 4a within the sight gauge floats and indicates the water level within the reservoir to the user. At the top of the reservoir 3, the lid 5 joins the reservoir 3 at the hinge 5a. Opposite the hinge 5a, the lid 5 has a tab 5c that a user grasps to lift the lid 5 for adding water. Beneath the lid 5, the tray 6c depends above the base 2. In this view, the right end of the tray 6c has a handle 6d extending perpendicular to the tray 6c and suitable for gripping by a consumer's forefinger just under the shelf 5b.

FIG. 12 shows the left side of the invention 1. Here the wire 2b enters the base 2 and the reservoir 3 extends upwardly from the base 2. As in the left side, the reservoir 3 curves upwardly with the back deflecting gently towards the hinge 5a and the front curving sharply ahead of the tray 6c. The tray 6c on the left end has a depending pin, contained within the front curve of the left side of the reservoir 3. The front curve has a cylindrical hole to receive the pin. With the tray 6c in a pin connection with the front curve, the tray 6c rotates inward and outward from the reservoir 3 for a user to add and to remove coffee grounds, and to clean the tray 6c.

From above, the invention 1 appears as in FIG. 13. The base 2 has a generally round shape beneath the reservoir 3. Between the front curves of the left and right sides of the reservoir 3, the base 2 has a plate upon which a heated cup rests. The plate has a pattern of holes to insulate the base 2 from a heated cup. Towards the right side, the reservoir 3 curves upward and contains the sight gauge 4 and ball 4a. Inwards from the handle 6d, the lid 5 has a wedge like portion removed to expose a flat shelf 5b. The shelf 5b has cutouts that admit buttons 10 and a light 11 in a symmetric arrangement. A brew button 10 activates brewing through the tray 6c, and the other button 10 stops brewing. The light 11 or LED between the buttons 10 illuminates when the brew button 10 is pressed, thus showing the consumer that the brewing is in progress. Outwards of the light 11, the lid 5 has a tab 5c that permits the consumer to lift the lid 5.

In operation, the present invention 1 accounts for variation in the amount of water placed in the reservoir 3 for brewing. When the reservoir 3 has no water and a consumer presses a BREW button 10, the LED illuminates during the brewing cycle. The LED then turns off at the end of the brewing cycle or when the consumer presses the STOP button 10a.

When the reservoir 3 has water, a consumer places a cup into the present invention 1 and presses the BREW button 10 above the cup. The LED 11 illuminates and coffee brews until the consumer presses the STOP button 10a or the reservoir 3 empties of water and the present invention 1 automatically stops operating. Then the LED turns off, alerting the consumer to a cup full of coffee.

Opposite to FIG. 13, the bottom view of the invention 1 appears in FIG. 14. Upon the circular portion, the base 2 has two or more feet 2d to stabilize the invention 1 when standing upright.

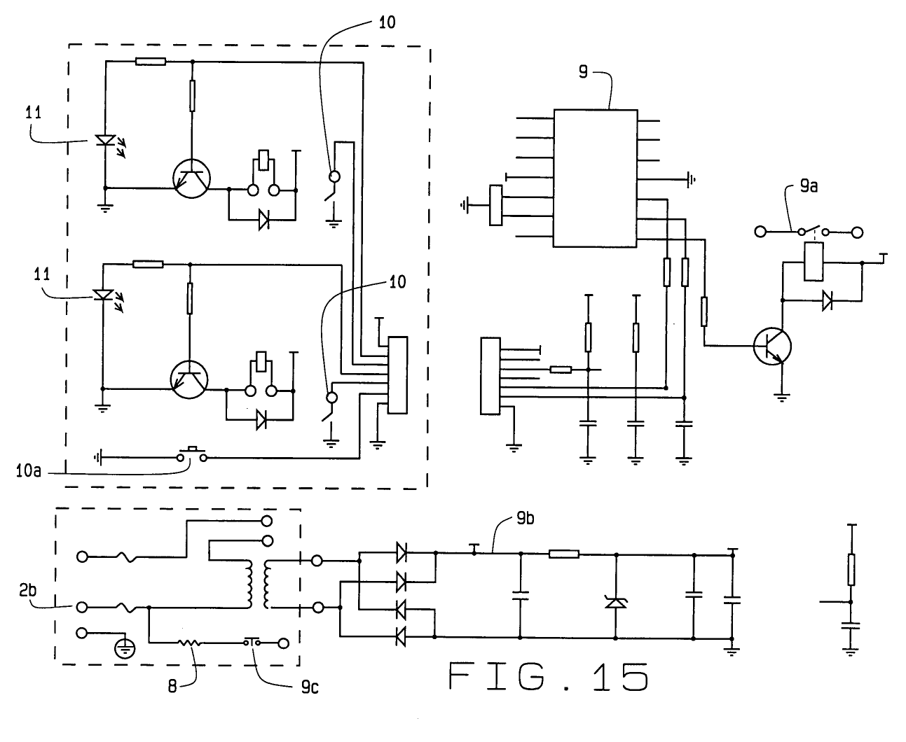

The present invention operates electrically in homes, offices, and workplaces. FIG. 15 shows the circuitry for the two cup embodiment. Viewing FIG. 15 in a clockwise direction, the control assembly 9 regulates the operation of the present invention with a microprocessor. Adjacent to the control assembly 9, a solenoid switch 9a stops the heating of the water in event of dry boil or overfilling of a cup. The self locking circuit 9b interfaces with the solenoid switch 9a to cease the delivery of heat to the water in the reservoir. The water is heated by a heater 8 powered from line 2b voltage and protected by a thermostat 9c. In particular, the contact labeled LO of the thermostat 9c operates via the solenoid switch 9a to open the circuit to contacts labeled LIN1 LIN2. When the solenoid switch opens, as when the heater reaches a certain temperature, heating of the water stops thus preventing an accidental fire or other incident. A user operates the present invention 1 by pressing either or both BREW buttons 10 to illuminate the LED 11. The user presses the STOP button 10a to cease brewing as desired.

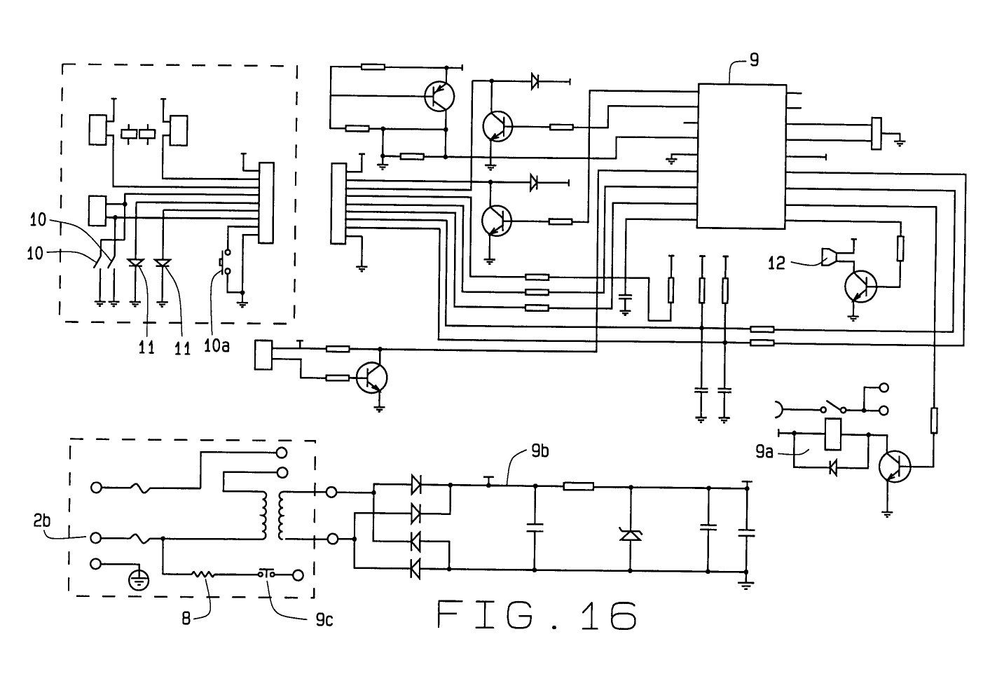

FIG. 16 shows the circuitry for the alternate two cup embodiment, with a beeper or other sound generator. Proceeding clockwise direction, the control assembly 9 regulates the operation of the present invention with a microprocessor. A beeper 12, buzzer, or other sound generator provides another indicator to the user regarding the status of the brewing cycle. When the brewing cycle ends, the beeper activates and its sound alerts a user. Proximate to the beeper 12 and the control assembly 9, a solenoid switch 9a stops the heating of the water in event of dry boil or overfilling of a cup. The self locking circuit 9binterfaces with the solenoid switch 9a to cease the delivery of heat to the water in the reservoir. The water is heated by a heater 8 powered from line 2b voltage and protected by a thermostat 9c. As before, the contact labeled LO of the thermostat 9c operates via the solenoid switch 9a to open the circuit to contacts labeled LN1 LN2. When the solenoid switch opens, as when the heater reaches a certain temperature, heating of the water stops thus preventing an accidental fire or other incident. A user operates the present invention 1 by pressing either or both BREW buttons 10 to illuminate the LED 11. The user presses the STOP button 10a to cease brewing as desired.

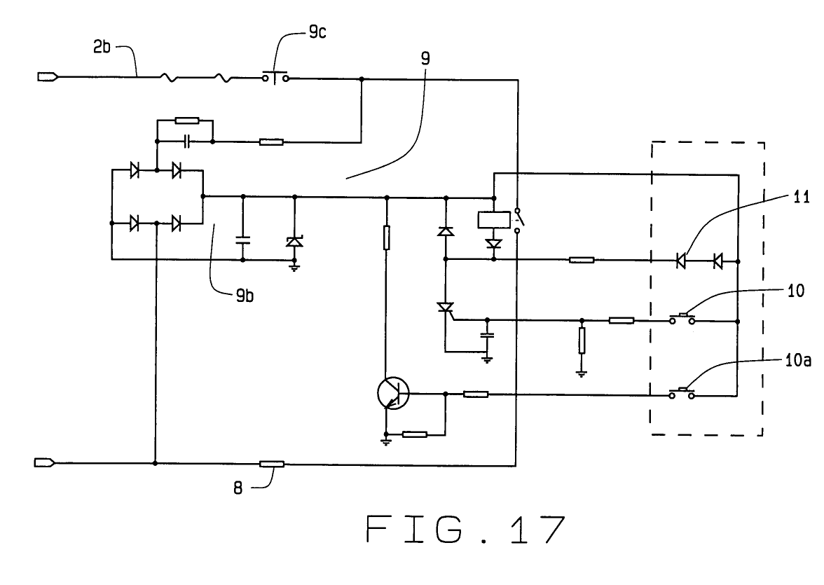

FIG. 17 shows the circuitry for the single cup embodiment where the user operates the present invention by pressing the BREW button 10 and illuminating the LED 11. When desired, the user presses the STOP button 10a to cease brewing. Behind the buttons 10, 10a, the control assembly 9 regulates operations of the present invention. The control assembly 9 has a self locking circuit 9b to prevent damage from dry boiling and uses a relay thermostat 9c to activate the self locking circuit 9b upon attainment of certain temperature conditions. As before, a heater 8 heats the water in the reservoir for brewing coffee by the present invention. The heater 8 and the remainder of the present invention have electrical service supplied by line 2b.

The concept of this invention is to encourage use of single or double cup amounts of coffee and water through a readily opened and cleaned tray. Further, this invention has a sight gauge and floating ball to indicate the water level in an otherwise opaque reservoir.

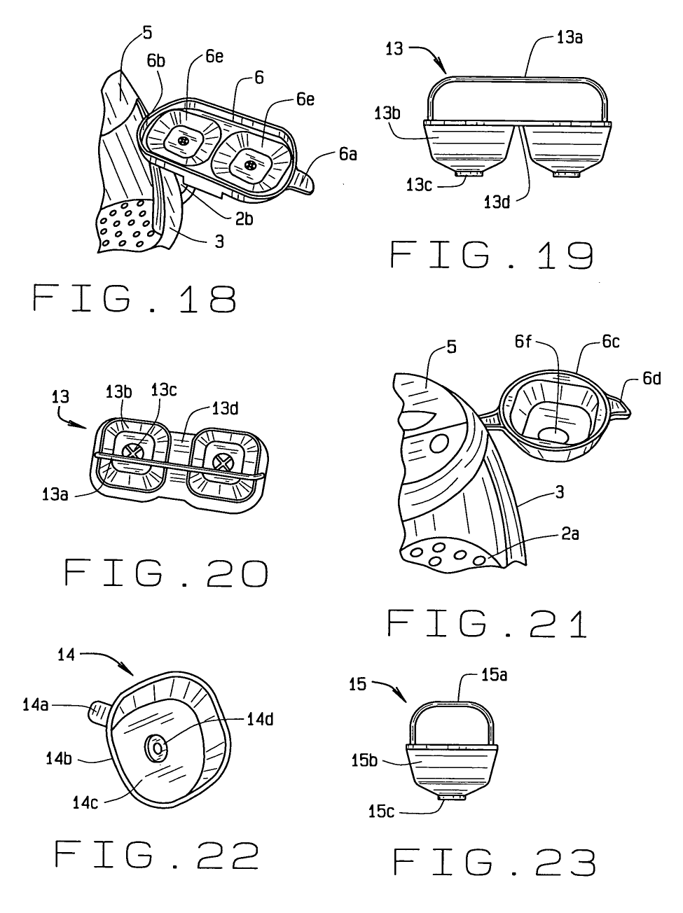

The two cup tray 6 appears in FIG. 18. Here, the tray has been opened outwards from the reservoir 3 by pulling on the handle 6A. The tray rotated upon the pin 6b which revealed two chambers 6e formed into the tray. The chambers each have a centered bottom hole for releasing water as coffee into one or two cups below in the brewer. Each chamber has a generally rectangular shape with an inverted pyramidal bottom having four faces. The chambers 6e admit a filter 13 upon the tray that contains ground coffee.

FIG. 19 shows the two cup filter 13 that has a handle 13A joining two spaced apart baskets 13B that have a similar shape as the chambers of the tray. The handle joins to the outermost edges of the two baskets. Alternatively, the handle has a hinged connection to the baskets that permits folding for when the tray is closed upon the brewer as in FIG. 1. Each basket has a shape to match that of the chambers, generally a four sided funnel with a centered aperture 13C through which brewer coffee passes to a cup or mug beneath. The baskets are joined upon their innermost edges by a gusset 13D that extends substantially along the length of the innermost edges of the baskets.

Turning the filter 13 upwards, FIG. 20 shows the interior of the baskets 13B. Below the handle 13a, each basket 13B has a depressed wall, generally formed into a rectangle. The wall continues downwards or away from the handle as an inverted pyramidal or conic section. At the lowest and narrowest point, each basket has an aperture 13C that releases brewed coffee into a mug or cup for consumption by the user. Between the two baskets, a gusset 13D stiffens the filter 13 and prevents the two baskets from collapsing inwards. The two cup filter is washable, generally symmetric and can be stacked for bulk sales.

After introducing the single cup brewer in FIG. 8, the tray 6c opens with a pull on handle 6d which opens the tray away from the brewer with its top shown at 5 here in FIG. 21. The single cup tray has a chamber 6f that has a generally four sided funnel shape with an inverted pyramidal or conic section shaped bottom. The chamber has an aperture at its lowest point for release of brewed coffee. To prevent escape of coffee grounds into a user's mug, the tray has a disposable basket 14 shown in FIG. 22. The basket has a similar shape to the chamber, here shown as a four sided funnel with rounded corners. This basket has a tab 14A that assists the user in grasping the basket or removing this basket from the tray 6c. The perimeter edge 14B of the basket is widened and thickened slightly to stiffen the basket and prevent collapse or slippage of the basket into the chamber. Beneath the perimeter edge, the basket has a wall 14C that slopes downwards to an aperture 14D. The basket retains the coffee grounds while the aperture 14D releases brewed coffee through the aperture in the tray 6c, and then into a cup or mug beneath for consumption.

And, FIG. 23 shows the one cup filter 15 that has a handle 15A that extends upward and over a lone basket 15B of a similar shape as the chamber of the tray. The handle joins to the outermost edges of the lone basket. Alternatively, the handle has a hinged connection to edges that permits folding when the tray is closed upon the brewer as in FIG. 8. Each basket has a shape to match that of the chamber, generally a four sided funnel with a centered aperture 15C through which brewer coffee passes to a cup or mug beneath.

From the aforementioned description, a limited cup coffeemaker has been described. The limited cup coffeemaker is uniquely capable of regulating heating of water depending on the volume of water present in a reservoir. The limited cup coffeemaker and its various components may be manufactured from many materials including but not limited to polymers, polyvinyl chloride, polyethylene, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

Variations or modifications to the subject matter of this invention may occur to those skilled in the art upon reviewing the summary of the invention as defined herein, and upon undertaking a study of the description of its preferred embodiment. Such variations, if within the spirit of this development, are intended to be encompassed within the scope of the invention as shown and described herein. The specific depiction of the invention, as described, and as shown in the drawings, is set forth for illustrative purposes only.

I claim:

1. A machine to make coffee within at least one cup comprising:
a base;
a reservoir upon said base and having an upright form;
a lid hingedly connected to said reservoir;
a tray beneath said lid and forward of said reservoir for containing coffee grounds;
piping in communication with said reservoir;
a heater adjacent to said piping;
a control assembly for said heater;
at least one switch in communication with said control assembly for a consumer to brew coffee, and said machine brewing coffee automatically;
at least one means to indicate brewing proximate to said at least one switch;
whereby, a user fills said reservoir with water and said tray with coffee grounds, places a cup upon said base, presses said switch to start brewing, said heater heats said piping thereby heating water that rises through said piping and under said lid into said tray, and said control assembly ceases heating once said cup is full.

2. The coffee making machine of claim 1 further comprising:
said reservoir having at least one chamber able to contain a cup placed therein by a user, said at least one chamber being upright and having a radius of curvature sufficient for a rounded cup and a location generally centered upon said base; and,
a stop switch for termination of brewing and permitting brewing of less than one cupful of coffee upon selection of the user.

3. The coffee making machine of claim 2 further comprising:
said reservoir having two of said chambers and a spine between and parallel to said chambers, said spine being truncated to admit said tray; and,
said control assembly having a solenoid switch.

4. The coffee making machine of claim 1 further comprising: said control assembly having a self lock circuit.

5. The coffee making machine of claim 4 wherein said self lock circuit has a relay method thermostat.

6. The coffee making machine of claim 1 further comprising:
said control assembly having a water sensor, said water sensor communicating with said control assembly so that one cupful of coffee is brewed when one cupful is selected and water volume in said reservoir exceeds on cup; and,
said reservoir having an overflow hole for when water volume introduced into said reservoir exceeds two cupfuls.

7. The coffee making machine of claim 1 further comprising:
a sight gauge upon said reservoir and visible to a user of said machine, said sight gauge indicating the level of water within said reservoir.

8. The coffee making machine of claim 1 further comprising:
said indicator means having light emitting diodes.

9. The coffee making machine of claim 1 wherein said indicator means is one of a liquid crystal display, beeper, or buzzer.

10. The coffee making machine of claim 1 further comprising:
said tray having at least one filter chamber, said filter chamber having an inverted partially conical shape with an aperture at the lowest point; and,
a filter locating within said filter chamber, said filter having at least one basket, said basket receiving coffee grounds and fitting snugly within said filter chamber, said basket having an aperture in communication with said aperture of said tray.

11. The coffee making machine of claim 10 further comprising:
said tray having two of said filter chambers;
said filter having two of said baskets arranged side by side, and a handle over said baskets.

12. The coffee making machine of claim 10 wherein said tray has one of said filter chambers; said filter has one of said baskets, and said basket has one of a tab or a handle over said basket to ease removal of said basket from said chamber.

13. A method of controlling the making of coffee comprising:
filling a reservoir with water;
assessing the level of water visually through a gauge upon the reservoir;
placing coffee grounds into a tray adjacent to the top of the reservoir;
positioning a cup beneath the tray;
pressing a switch to activate the brewing cycle; and,
removing the cup at cessation of the brewing cycle.

14. The controlling method of claim 13 further comprising:
said brewing cycle having heating of water, communicating the heated water to the tray, and thermostatic control of the duration of heating;
whereby upon heating a sufficient amount of water, said thermostatic control ceases said brewing cycle.

15. The controlling method of claim 13 further comprising: said switch pressing triggers a means to indicate brewing.

16. The controlling method of claim 15 wherein said indicator means is one of light emitting diodes, liquid crystal display, beeper, or buzzer.

17. The machine of claim 1 further comprising:
a drip tray upon said base providing a shallow space for collecting coffee spills.

18. The machine of claim 17 wherein said drip tray is removable.
